(19) United States
(12) Patent Application Publication
(10) Pub. No.: US 2024/0187773 A1
(43) Pub. Date: Jun. 6, 2024

(54) NECKLACE EARPHONES

(71) Applicant: OXTI Pte Ltd, Singapore (SG)

(72) Inventor: CHIH-FENG HO, Singapore (SG)

(21) Appl. No.: 18/074,538

(22) Filed: Dec. 5, 2022

(51) Int. Cl. H04R 1/10

(52) U.S. Cl. CPC H04R 1/1016; H04R 1/105; H04R 1/1066; H04R 2420/07

(57) ABSTRACT

Necklace earphones includes: a plurality of earphone bodies; a chain body, positioned on one side of the plurality of earphone bodies; a plurality of first connecting parts, the first connecting portion respectively provided on the plurality of earphone bodies; and a plurality of second connecting parts, the second connecting part respectively provided on the ends of the chain body, and the second connecting part respectively connected with the plurality of first connecting parts. With the above structure, the present invention can prevent the plurality of earphone bodies from being lost or dropped after being removed, and allows the plurality of earphone bodies to be easily found through the chain body.

### (a) TECHNICAL FIELD OF THE INVENTION

The present invention relates to earphones, and more particularly to wireless earphones.

### (b) DESCRIPTION OF THE PRIOR ART

For example, in Chinese Patent No. CN212343386U. titled “charging system for wireless earphones”, the earphone body, as shown in FIG. 1 of the patent shows, the earphone body is divided into a left earphone and right earphone. Wireless earphones means that there is no wire (earphone cable) connected between the left earphone and right earphone, and the left earphone and right earphone can be connected to work through wireless transmission technology. One of the main reasons for users to choose this type of earphones is to eliminate the hassle of adjusting the earphone cables and to prevent them from tangling around sports equipment when exercising (or bodybuilding). In generally traditional wired earphones, the lengthy wires often hit the human body, face, or even pull the earphone body during the running and jumping process, causing the earphone body to fall off, which makes the entire exercise process quite unpleasant.

However, the above patent has the following disadvantage: the earphone body is apt to fall off due to the human body's shaking upon exercise, and it easily drop to a hidden corner due to the small volume thereof, which causes it difficult to be found.

### SUMMARY OF THE INVENTION

To overcome the above disadvantages, the present invention proposes necklace earphones, including: a plurality of earphone bodies; a chain body, positioned on one side of the plurality of earphone bodies and has a first end and second end; a plurality of first connecting parts, the first connecting portion respectively provided on the plurality of earphone bodies; and a plurality of second connecting parts, the second connecting part respectively provided on the first end and second end of the chain body, and the second connecting part respectively connected with the plurality of first connecting parts,
where the first connecting part and second connecting part respectively are a magnet, suction cup, Velcro tape or snap,
where the first connecting part and corresponding second connecting part are a concave convex fit or convex concave fit structure,
where one side of each of the plurality of earphone bodies is provided with a binding piece, and the plurality of earphone bodies are connected together through the binding pieces,
and where the chain body is a necklace.

With the above structure, the present invention can prevent the plurality of earphone bodies from being lost or dropped after being removed, and allows the plurality of earphone bodies to be easily found through the chain body.

### BRIEF DESCRIPTION OF THE DRAWINGS

FIG. 1 is a schematically perspective view of necklace earphones of the present invention;

FIG. 2 is an exploded view of the necklace earphones of the present invention;

FIG. 3 is a schematic view of the necklace earphones of the present invention in a first use state; and

FIG. 4 is a schematic view of the necklace earphones of the present invention in a second state.

### DETAILED DESCRIPTION OF THE PREFERRED EMBODIMENTS

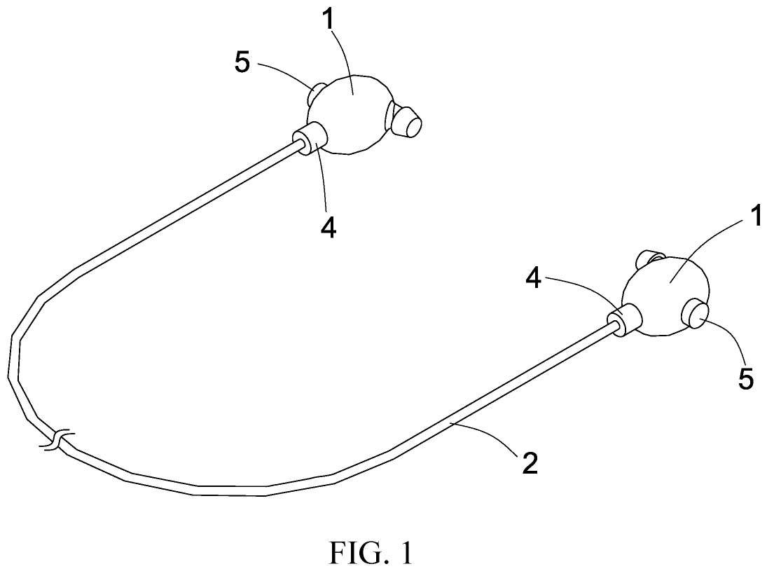

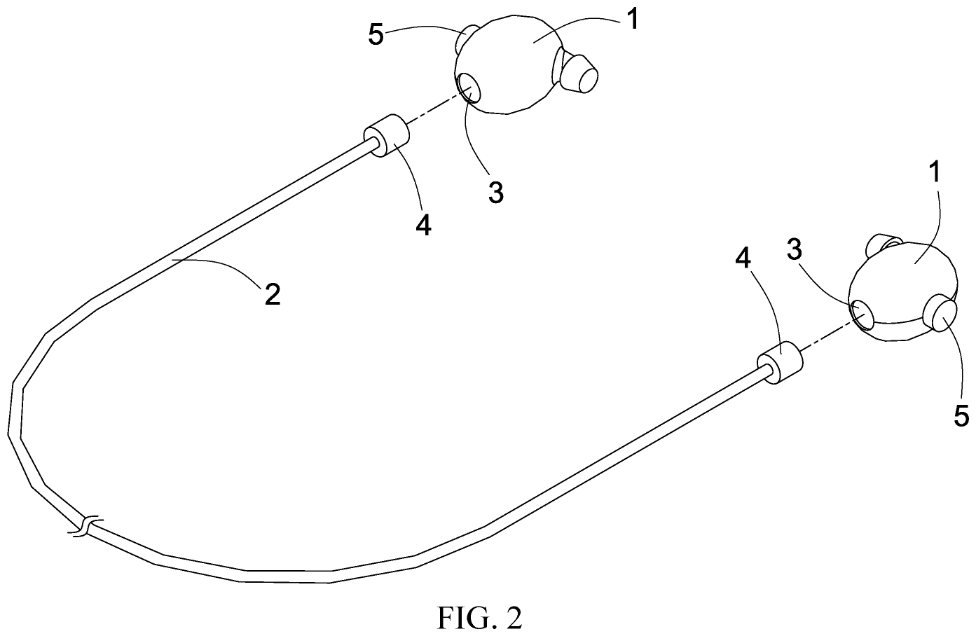

Referring to FIGS. 1 and 2, necklace earphones of the present invention include a plurality of earphone bodies 1, a chain body 2, a plurality of first connecting parts 3, and a plurality of second connecting parts 4.

Each of the plurality of earphone body 1 may be a wireless earphone.

The chain body 2 is positioned on one side of the plurality of earphone bodies 1. The necklace body 2 may be a necklace.

The first connecting part 3 is respectively provided on the plurality of the earphone bodies.

The second connecting part 4 is respectively provided on the both ends of the chain body 2 and may be respectively connected with the plurality of first connecting parts 3. The plurality of first connecting parts 3 and the plurality of second connecting parts 4 each may be any one chosen from the group constituted by magnet, suction cup, Velcro tape and snap, but the present invention is not so limited. For example, the first connecting part 3 and second connecting part 4 both are magnets with opposite magnetic properties, or the first connecting part 3 is a magnet and the second connecting part 4 is a metal piece, or the first connecting part e is a metal piece and the second connecting part 4 is a magnet.

The first connecting part 3 and the corresponding second connecting part 4 may be a concave convex or convex concave fit structure. For example, the first connecting portion 3 is provided with a convex portion, the corresponding second connecting portion 4 a concave portion, and the convex portion of the first connecting part 3 and the concave portion of the corresponding second connecting part 4 are match in shape; the convex portion of the first connecting part 3 can be engaged with the concave portion of the corresponding second connecting part 4. Alternatively, the first connecting part 3 is provided with a concave portion, the corresponding second connecting part 4 a convex part, and the both are matched in shape; the convex portion of the second connecting part 4 can be engaged with the concave portion of the corresponding first connecting part 3.

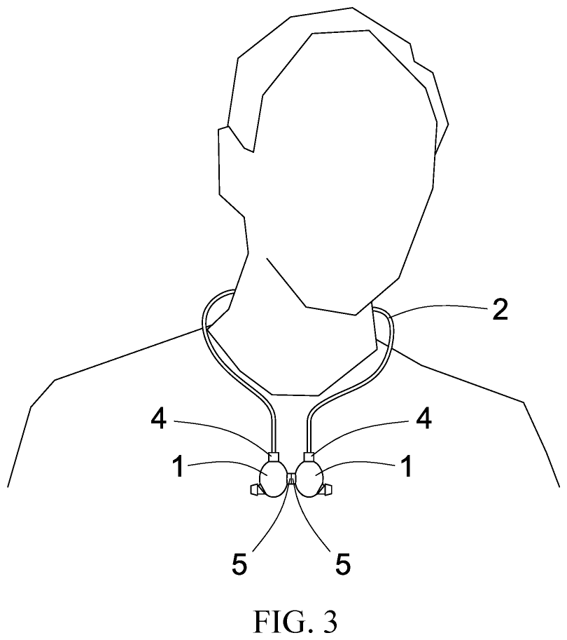

Referring to FIGS. 2 and 3, one side of each of the plurality of earphone bodies 1 may be provided with a binding piece 5 and the plurality of earphone bodies are connected with each other through the binding pieces 5. The binding pieces 5 can be connected to each other by means of concave-convex or convex-concave fitting, an engaging structure, or a snap-fit structure. Here, the engaging structure is, for example, an insert groove and insert block; the snap-fit structure is, for example, a buckle groove and buckle

Referring to FIGS. 2 and 3 again, a user can hang the plurality of earphone bodies on their neck through the chain body 2, or can release the plurality of second connecting parts 4 from the plurality of first connecting parts 3, allowing the chain body 2 and the plurality of earphone bodies 1 to be separated from each other so as to be conveniently stored in their clothes pocket after the earphones of the present invention is used. Since the chain body 2 and the plurality of earphone bodies 1 are separable, there is no large volume, which makes them easy to carry or store, and not waste storage space.

After the present invention is used, the plurality of second connecting parts 4 can be maintained in connection with the plurality of first connecting parts 3, allowing the chain body 2 to be connected with the plurality of earphone bodies, and the earphones of the present invention in this state is then stored in the backpack. Since the chain body 2 is in connection with the plurality of earphone bodies 1, the volume is larger for easy removal to use.

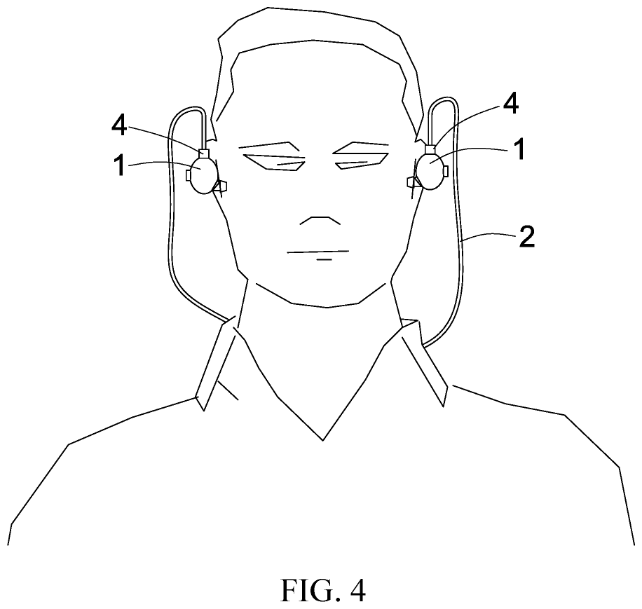

Referring to FIG. 4, when the earphones of the present invention is used, a user can wear the plurality of earphone bodies 1 on the head. Since the chain body 2 is in connection with the plurality of earphone bodies 1, no single earphone body 1 will be lost or dropped. When the plurality of earphone bodies 1 are caused to be dropped upon exercise or violent collision, the plurality of earphone bodies 1 can be easily found through the chain body 2 because the chain body 2 is in connection with the plurality of earphone bodies 1.

With the above structure, the present invention can prevent the plurality of earphone bodies 1 from being lost or dropped after being removed, and allows the plurality of earphone bodies 1 to be easily found through the chain body 2. The present invention allows users to do whatever they want when exercising or bodybuilding, without worrying about the earphone body 1 falling off.

I claim:

1. Necklace earphones, comprising:
a plurality of earphone bodies;
a chain body, positioned on one side of said plurality of earphone bodies;
a plurality of first connecting parts, said first connecting portion respectively provided on said plurality of earphone bodies; and
a plurality of second connecting parts, said second connecting part respectively provided on both ends of said chain body, and said second connecting part respectively connected with said plurality of first connecting parts.

2. The necklace earphones according to claim 1, wherein said first connecting part and second connecting part respectively are a magnet, suction cup, Velcro tape or snap.

3. The necklace earphones according to claim 1, wherein said first connecting part and corresponding second connecting part are a concave convex fit or convex concave fit structure.

4. The necklace earphones according to claim 1, wherein one side of each of said plurality of earphone bodies is provided with a binding piece, and said plurality of earphone bodies are connected together through said binding pieces.

5. The necklace earphones according to claim 1, wherein said chain body is a necklace.
